(19) United States
(12) Patent Application Publication
(10) Pub. No.: US 2013/0269603 A1
(43) Pub. Date: Oct. 17, 2013

(54) APPARATUS FOR COLORING CODING A TOOL BIT

(71) Applicant: Shao-Hsien Hsu, Taichung City (TW)

(72) Inventor: Shao-Hsien Hsu, Taichung City (TW)

(21) Appl. No.: 13/912,188

(22) Filed: Jun. 6, 2013

Related U.S. Application Data
(63) Continuation-in-part of application No. 13/299,361, filed on Nov. 18, 2011.
Application No. 13/299,361 is a continuation-in-part of application No. 12/395,680, filed on Mar. 1, 2009, now abandoned.

(51) Int. Cl. B05C 13/02

(52) U.S. Cl. CPC B05C 13/02
USPC 118/232

(57) ABSTRACT

An apparatus for color coding a tool bit includes a motor, a paint supply device, a brush, a lifting mechanism and a control unit. The motor includes a shaft onto which the tool bit is positioned. The paint supply device is provided for ejecting dyestuff therefrom. The brush is arranged to absorb the dyestuff from the paint supply device. The lifting mechanism is configured to move the paint reservoir and the brush together to have the brush contact with or depart from the tool bit. The control unit includes a pedal-type switch for activating the lifting mechanism, the motor and the paint supply device together in order to have the tool bit be annularly colored.

### CROSS-REFERENCE TO RELATED APPLICATION

This is a continuation-in-part of the co-pending application Ser. No. 13/299, 361, filed on Nov. 18, 2011, which is a continuation-in-part of application Ser. No. 12/395,680, filed on Mar. 1, 2009, now abandoned.

### BACKGROUND OF THE INVENTION

1. Field of the Invention

The present invention relates to an apparatus for color coding a tool bit, and more particularly to an apparatus for color coding a tool bit by painting.

2. Description of Related Art

A conventional recognizable tool bit includes a head, a neck connected to the head, and an inserter connected to the neck. An aluminum-alloy recognizable ring is sleeved on the neck. The recognizable ring has an outer periphery protruding from the neck. A color of the recognizable ring is provided for recognizing a standard, of the tool bit.

The conventional recognizable tool bit provides a recognizable effect for a user to easily recognize the standard of the tool bit during operation. However, it is inconvenient to sleeve the recognizable ring on the neck of the tool bit. Furthermore, the aluminum-alloy recognizable ring increase the production cost.

In addition, the conventional apparatus for coloring tools often has a lever or a steering wheel for an operator to start/stop the coloring process by hands. Nevertheless, it is inefficient in the assembling line and it also reduces the quality of the products because the operator cannot use two hands to control the apparatus and to collect the finished products at the same time.

The present invention has arisen to mitigate and/or obviate the disadvantages of the conventional recognizable tool bit.

### SUMMARY OF THE INVENTION

It is an objective of the present invention to provide an improved apparatus for color coding a tool bit.

To achieve the objective, the apparatus includes a motor, a paint supply device, a brush and a lifting mechanism. The motor includes a shaft having a distal end formed with a hexagon receptacle configured to receive a hex end of the tool bit in a coaxial manner. The paint supply device includes a paint reservoir and a pneumatic device. The pneumatic device is connected to the paint reservoir for ejecting dyestuff from the paint reservoir. The brush is arranged to absorb the dyestuff from the paint reservoir. The lifting mechanism is configured to move the paint reservoir and the brush together with respect to the motor between an upper position where the brush is spaced from the tool bit inserted in the hexagon receptacle of the shaft of the motor, and a lower position where the brush is in contact with a side surface of the tool bit. The control unit is electrically connected to the lifting mechanism, the motor, and the pneumatic device, and includes a pedal-type switch for activating the lifting mechanism, the motor and the pneumatic device such that the lifting mechanism moves the paint reservoir and the brush to the lower position and stay in the lower position for a first period of time, the pneumatic device ejects the dyestuff from the paint reservoir into the brush for a second period of time, and the motor drives the tool bit to rotate for a third period of time so as to have the tool bit be annularly colored. The lifting mechanism lifts the paint reservoir and the brush back to the upper position upon the first period of time is finished. The pneumatic device stops ejecting the dyestuff from the paint reservoir upon the second period of time is finished. And, the motor stops driving the tool bit to rotate upon the third period of time is finished.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an apparatus for color coding a tool bit in accordance with the present invention;

FIG. 2 is a side view of the apparatus shown in FIG. 1;

FIG. 3 is a view similar to FIG. 2, illustrating the motion of a lifting mechanism of the apparatus;

FIG. 4 is a partial enlarged view of the apparatus in FIG. 3, illustrating the rotation of a shaft of a motor of the apparatus; and

FIG. 5 is a perspective view of a recognizable tool bit colored by the apparatus in accordance with the present invention.

### DETAILED DESCRIPTION OF EMBODIMENTS

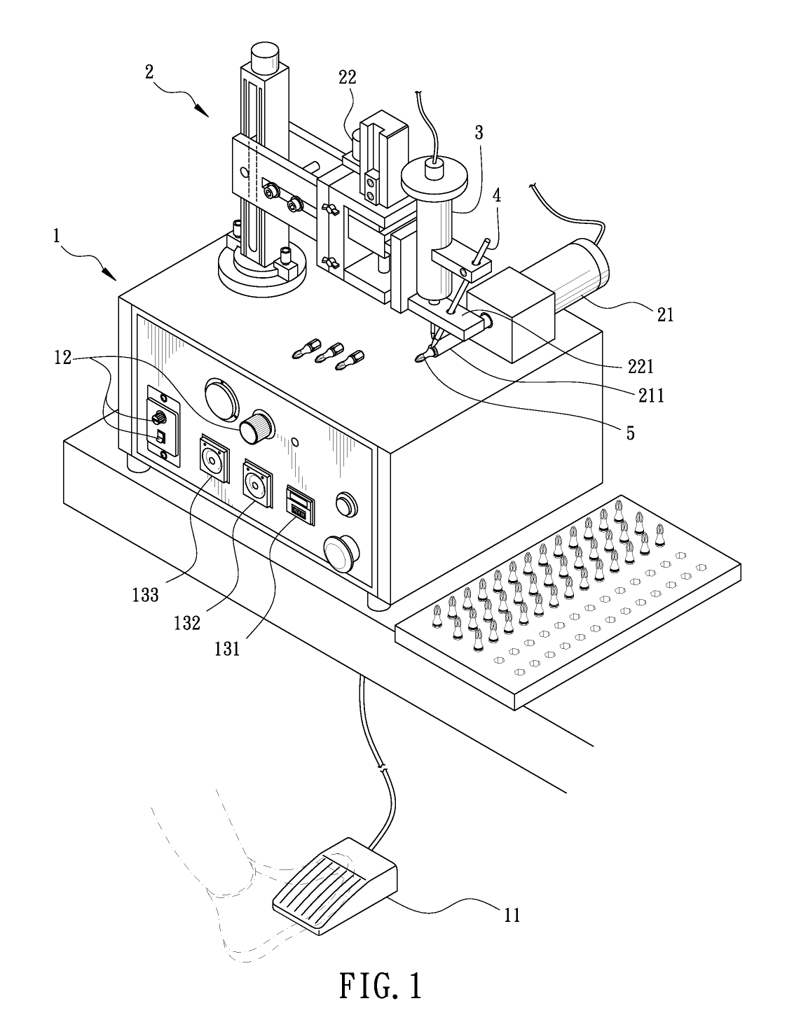

Referring to the drawings and initially to FIGS. 1-5, an apparatus for color coding a tool bit 5 for recognition in accordance with the preferred embodiment of the present invention comprises a control unit 1 and a decorating unit 2 mounted on an upper platform 10 of the control unit 1. The control unit 1 is electrically connected to the decorating unit 2 for control motion of the decorating unit 2.

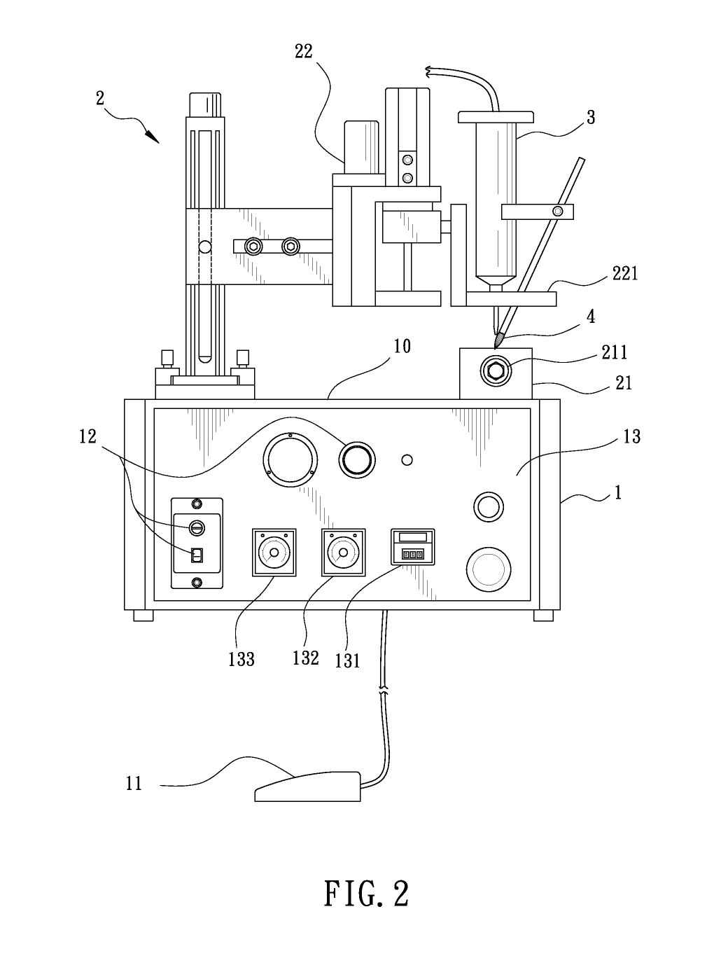

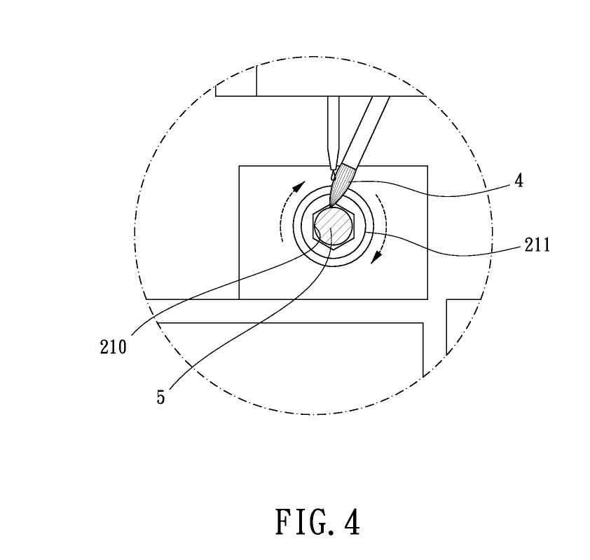

As shown in FIGS. 1 and 2, the decorating unit 2 includes a motor 21, a lifting mechanism 22 mounted adjacent to the motor 21, a paint supply device 3 and a brush 4, wherein the paint supply device 3 and a brush 4 are mounted on the lifting mechanism 22. Specifically, the paint supply device 3 and the brush 4 are both mounted on a bracket 221 of the lifting mechanism 22 so that the paint supply device 3 and the brush 4 can be lifted up and down together by the lifting mechanism 22. The motor 21 has a shaft 211. The shaft 211 is formed on a distal end with a hexagon receptacle 210, as best seen in FIG. 4, to receive the tool bit 5 inserted in an axial direction of the hexagon receptacle 210. The paint supply device 3 includes a paint reservoir 3 and a pneumatic device (not shown) connected to the paint reservoir 3 for ejecting dyestuff from the paint reservoir 3 to the brush 4. The brush 4 then absorbs the dyestuff and transfers the same an outer periphery of the tool bit 5.

The control unit 1 has a pedal-type switch 11 and a panel 13. The panel 13 is provided thereon with a supplying counter display 131, a contacting counter display 132, a rotating counter display 133 and a set of control knobs 12. The switch 11 is provided for turning on the decorating unit 2. The supplying counter display 131 is provided for showing an ejecting time for which the pneumatic device ejects the dyestuff from the paint reservoir 3 into the brush 4. The contacting counter display 132 is provided for showing a contact time for which the brush 4 contacts with the tool bit 5. The rotating counter display 133 is provided for showing a rotating time for which the motor 21 drives the tool bit 5 to rotate with the shaft 211. The set of the control knobs 12 is provided for adjusting the aforementioned ejecting time, the contact time as well as the rotating time in order to control a thickness of a colored layer of the tool bit 5.

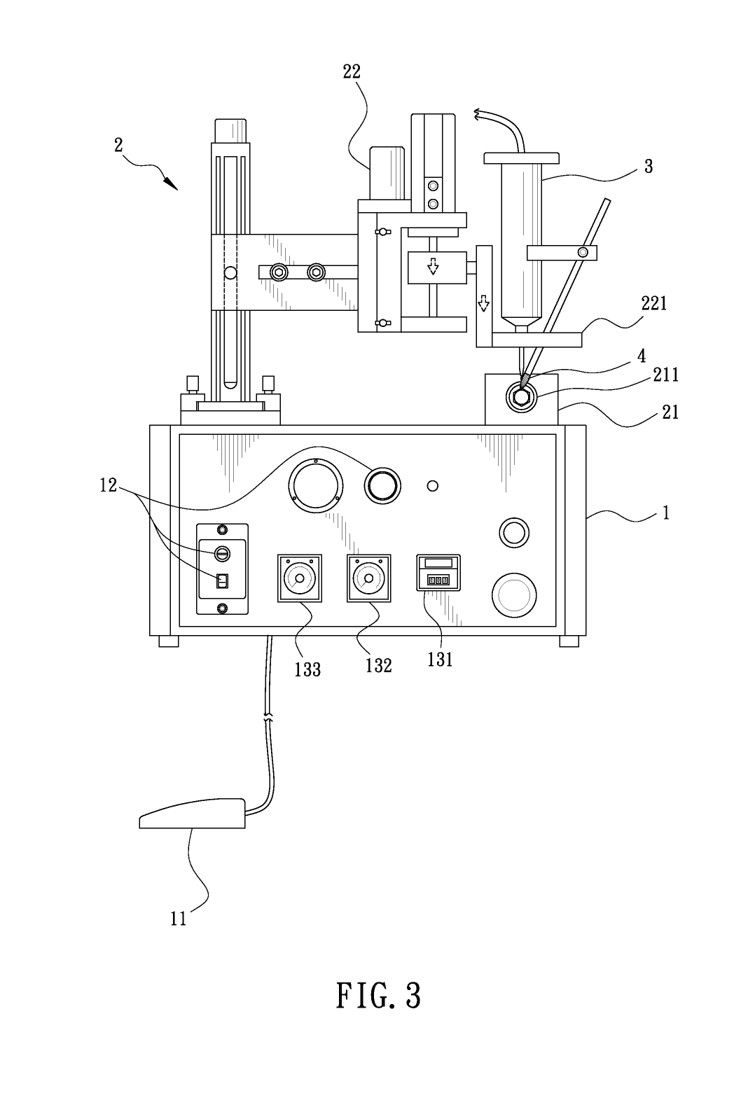

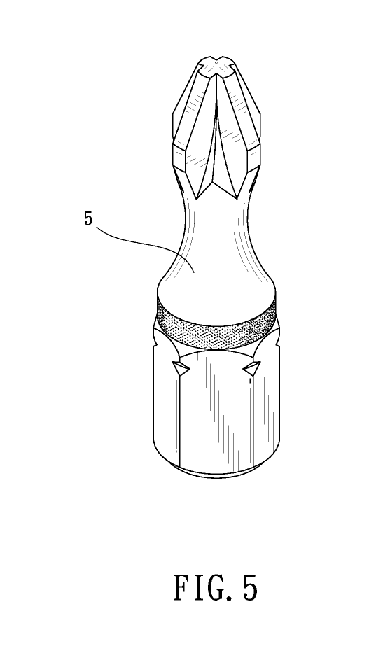

When operating, the tool bit 5 is positioned on the shaft 211. The control knobs 12 are adjusted to determine the flow rate or the ejecting time of the dyestuff, the contact time, and the number of cycles of the shaft 211. An operator then pedals the pedal-type switch 11 to turned on the decorating unit 2. Thus, the shaft 211 of the motor 21 rotates the tool bit 5. The lifting mechanism 22 carries the paint supply device 3 and the brush 4 from an upper position (see FIG. 2) to a lower position (see FIG. 3) to have the brush 4 in contact with the tool bit 5. The paint supply device 3 injects the dyestuff in the brush 4. Since the brush 4 of the bracket 221 contacts with the tool bit 5, which is rotated by the motor 21, the tool bit 5 is annularly colored, as shown on FIGS. 4 and 5.

As shown above, the operator only pedals the pedal-type switch 11 to start coloring the tool bit 5 so that the operator can further use two hands to position the next tool bit 5 or to collect finished tool bits 5 sequentially, as shown in FIG. 1. It is understood that, upon the contact time is finished, the lifting mechanism 22 moves the bracket 221 and the paint supply device 3 back to the upper position, as shown in FIG. 2, to detach the brush 4 from the tool bit 5. The pneumatic device stops ejecting the dyestuff from the paint reservoir 3 upon the ejecting time is finished. And, upon the rotating time is finished, the rotation of the shaft 211 of the motor 21 is stopped. The colored tool bit 5 can be removed from the shaft 211 of the motor 21.

It is to be understood that the disclosed embodiments are illustrative in nature and the invention is not to be limited to any one or more embodiments except as set forth in the following claims.

What is claimed is:

1. An apparatus for color coding a tool bit, comprising:
a motor including a shaft having a distal end formed with a hexagon receptacle configured to receive a hex end of the tool bit in a coaxial manner;
a paint supply device including a paint reservoir and a pneumatic device connected to the paint reservoir for ejecting dyestuff from the paint reservoir;
a brush arranged to absorb the dyestuff from the paint reservoir;
a lifting mechanism configured to move the paint reservoir and the brush together with respect to the motor between an upper position where the brush is spaced from the tool bit inserted in the hexagon receptacle of the shaft of the motor, and a lower position where the brush is in contact with a side surface of the tool bit; and
a control unit electrically connected to the lifting mechanism, the motor, and the pneumatic device, and including a pedal-type switch for activating the lifting mechanism, the motor and the pneumatic device such that the lifting mechanism moves the paint reservoir and the brush to the lower position and stay in the lower position for a first period of time, the pneumatic device ejects the dyestuff from the paint reservoir into the brush for a second period of time, and the motor drives the tool bit to rotate for a third period of time so as to have the tool bit be annularly colored, wherein upon the first period of time is finished, the lifting mechanism lifts the paint reservoir and the brush back to the upper position; upon the second period of time is finished, the pneumatic device stops ejecting the dyestuff from the paint reservoir; and upon the third period of time is finished, the motor stops driving the tool bit to rotate.

2. The apparatus of claim 1, wherein the control unit further includes a panel formed thereon with a contacting counter display provided for showing a value of the first period of time, a supplying counter display provided for showing a value of the second period of time, a rotating counter display provided for showing a value of the third period of time, and a set of control knobs provided for manually adjusting the first, second and third periods of time in order to control a thickness of a colored layer of the tool bit.
